(19) United States
(12) Patent Application Publication
(10) Pub. No.: US 2017/0225354 A1
(43) Pub. Date: Aug. 10, 2017

(54) METHOD FOR PRODUCING BOARD

(71) Applicant: Panasonic Intellectual Property Management Co., Ltd., Osaka (JP)

(72) Inventor: Shigeki NAITO, Hyogo (JP)

(21) Appl. No.: 15/374,124

(22) Filed: Dec. 9, 2016

(30) Foreign Application Priority Data
Feb. 10, 2016 (JP) 2016-023955

(51) Int. Cl. B27N 3/00; C08L 97/02; B27N 1/02; B27N 3/04; B27N 3/08

(52) U.S. Cl. CPC B27N 3/002; B27N 3/04; B27N 3/08; B27N 1/0209; C08L 97/02

(57) ABSTRACT

A method for producing a board according to the present invention includes the steps of:
(A) dispersing a polycarboxylic acid, a saccharide, and ammonium sulfate in a collection of small wood pieces; and
(B) subjecting the collection of small wood pieces containing the dispersed polycarboxylic acid, saccharide, and ammonium sulfate to hot press molding to form a board comprising the small wood pieces bonded together.

### TECHNICAL FIELD

The present invention relates to a method for producing a board.

### BACKGROUND ART

In recent years, with increasing concerns about environmental issues such as global warming, resins obtained by polymerization of low-emission, carbon-neutral, plant-derived degradation products have been drawing attention as alternatives to petroleum-derived materials in the field of plastics.

In particular, polylactic acid obtained by polymerization of lactic acid, a degradation product derived from plants, is one of resins having crystallinity and higher physical properties than other plant-derived resins and also useful because it can be mass-produced at relatively low costs.

Unfortunately, polylactic acid has not been widely used yet because it is a thermoplastic resin whose heat resistance and mechanical properties are lower than those of petroleum-derived, general-purpose, thermoplastic resins (such as PE, PP, and ABS). In addition, polylactic acid does not have physical properties enough to replace petroleum-based thermosetting resin adhesives.

Traditionally, biomass-derived materials such as casein, soybean glue, and animal glue have been mainly used as adhesives for wood. However, since the physical and other properties of these materials are relatively poor, they have been replaced with petroleum-derived thermosetting resin adhesives such as urea, melamine, and phenolic adhesives. These adhesives are used to bond small wood pieces in the production of boards such as plywoods, particle boards, and fiberboards.

General adhesives for wood (urea-, melamine-, and phenol-based adhesives) are derived from petroleum and contain formaldehyde as a curing agent. These adhesives for wood are required to be water-based so that organic solvent emission can be reduced. These adhesives have the problem of formaldehyde emission, and the formaldehyde emission cannot be completely suppressed although some measures to reduce the emission are taken. There have also been developed petroleum-derived isocyanate adhesives with no formaldehyde emission. Unfortunately, such adhesives are not widely used because they have problems such as reaction with water and bonding with metal.

On the other hand, tannin and lignin, which are polyphenols contained in wood and bark, are produced as waste in sawmilling and pulp applications. Attempts for effective utilization of these materials have been made since a long time ago. For example, studies have been conducted on using, as an adhesive, a product obtained by condensation reaction of formaldehyde with tannin or lignin in a similar manner to phenolic resin, because tannin and lignin have a chemical structure similar to that of phenolic resin (see JP 3796604 B1). Studies have also been conducted on incorporating tannin or lignin into the polymer skeleton of phenolic resin by adding tannin or lignin to phenolic resin because tannin and lignin can be expected to react with the methylol groups in phenolic resin (see Mokushitsu Shinsozai Handbook (New Woody Materials Handbook), GIHODO SHUPPAN Co., Ltd., p. 361 and Wood Chemicals no Shintenkai (New Development of Wood Chemicals), CMC Publishing Co., Ltd., P. 225 (2007)).

Production of urethane resin by reaction of polyisocyanate with the phenolic hydroxyl groups of tannin or lignin has been studied as another attempt for effective utilization of tannin or lignin (see Wood Chemicals no Shintenkai (New Development of Wood Chemicals), CMC Publishing Co., Ltd., P. 225 (2007)).

Unfortunately, when formaldehyde is used to react with tannin or lignin, a problem can occur in that residual formaldehyde or formaldehyde generated by hydrolysis can be emitted. In addition, tannin and lignin are less reactive than conventional phenolic resin and thus inferior in physical properties and productivity. At present, therefore, the techniques mentioned above are not widely put into practical use.

Under these circumstances, it is proposed that boards should be produced from small wood pieces using an adhesive composed mainly of a polycarboxylic acid and a saccharide (see WO 2010/001988 A, JP 2012-214687 A, and JP 2014-51568 A). JP 2012-214687 A proposes that para-toluenesulfonic acid, a phosphate, or an organotitanium compound should be further added as a catalyst.

### SUMMARY OF INVENTION

### Technical Problem

However, the adhesives disclosed in WO 2010/001988 A, JP 2012-214687 A, and JP 2014-51568 A have further room for improvement in terms of the water resistance represented by the rate of weight decrease after boiling, for example, when they are to be used for floor materials. In particular, it has been demanded that water resistance enough to withstand practical use should be achieved without loss of bending strength.

An object of the present invention, which has been accomplished in view of the above circumstances, is to provide a board producing method capable of producing a highly water-resistant board with a low rate of weight decrease after boiling while preventing loss of bending strength in the process of producing the board using an adhesive including a polycarboxylic acid and a saccharide.

### Solution to Problem

In order to achieve the object described above, a method for producing a board according to the present invention includes the steps of:

(A) dispersing a polycarboxylic acid, a saccharide, and ammonium sulfate in a collection of small wood pieces; and

(B) subjecting the collection of small wood pieces containing the dispersed polycarboxylic acid, saccharide, and ammonium sulfate to hot press molding to form a board comprising the small wood pieces bonded together.

### Advantageous Effects of Invention

According to the present invention, a highly water-resistant board with a low rate of weight decrease after boiling can be obtained without loss of bending strength in the process of producing the board using an adhesive including a polycarboxylic acid and a saccharide.

### DESCRIPTION OF EMBODIMENTS

Hereinafter, embodiments of the present invention will be described.

The method of the embodiment for producing a board includes the steps (A) and (B) below.

The step (A) includes dispersing a polycarboxylic acid, a saccharide, and ammonium sulfate in a collection of small wood pieces.

The step (B) includes subjecting the collection of small wood pieces containing the dispersed polycarboxylic acid, saccharide, and ammonium sulfate to hot press molding to form a board including the small wood pieces bonded together.

The embodiment features the use of ammonium sulfate as a catalyst for the esterification reaction of the polycarboxylic acid with hydroxyl groups in the small wood pieces. When ammonium sulfate is used as the catalyst, a highly water-resistant board with a low rate of weight decrease after boiling can be obtained without loss of bending strength in the process of producing the board using an adhesive including a polycarboxylic acid and a saccharide.

In the step (A), the small wood pieces are those obtained from woody parts of plants or trees, bark, seeds, leaves, or others. The small wood pieces may be, for example, wood strands, wood chips, wood fibers, plant fibers, commercially available plant powder (such as bark powder), or chips obtained by crushing recycled materials.

In the embodiment, the board, which is produced by bonding such small wood pieces with an adhesive, may be, for example, a particle board, a fiberboard, or a medium-density fiberboard (MDF).

Among the polycarboxylic acid and the saccharide used for the adhesive in the step (A), the polycarboxylic acid may be any compound having a plurality of carboxyl groups. In some documents, the term “polybasic carboxylic acid” is also used to refer to polycarboxylic acid.

The polycarboxylic acid may be, for example, citric acid, tartaric acid, malic acid, succinic acid, oxalic acid, adipic acid, malonic acid, phthalic acid, sebacic acid, maleic acid, fumaric acid, itaconic acid, glutaric acid (1,5-pentanedioic acid), gluconic acid, glutaconic acid, or pentenedioic acid. The polycarboxylic acid may also be used in the form of an anhydride.

Among them, those produced from plants as raw materials are preferably used, such as citric acid, tartaric acid, malic acid, gluconic acid, sebacic acid, and itaconic acid. The use of plants as raw materials can reduce the use of fossil resources and thus makes it possible to obtain an adhesive with no environmental load. A single polycarboxylic acid may be used, or two or more polycarboxylic acids may be used in combination.

Among the polycarboxylic acid and the saccharide used for the adhesive in the step (A), the saccharide refers to a monosaccharide, a disaccharide, which is composed of monosaccharides joined by glycosidic linkage, an oligosaccharide, or a polysaccharide. The monosaccharide may be, for example, fructose, ribose, arabinose, rhamnose, xylulose, or deoxyribose. The disaccharide may be, for example, sucrose, maltose, trehalose, turanose, lactulose, maltulose, palatinose, gentiobiose, melibiose, galactosucrose, rutinose, or planteobiose. The oligosaccharide may be, for example, fructo-oligosaccharide, galacto-oligosaccharide, mannan-oligosaccharide, or stachyose. The polysaccharide may be, for example, starch, agarose, alginic acid, glucomannan, inulin, chitin, chitosan, hyaluronic acid, glycogen, or cellulose. A single saccharide may be used, or two or more saccharides may be used in combination.

The small wood pieces, which have a large number of hydroxyl groups, have high hydrophilicity and high affinity for an adhesive composed mainly of the polycarboxylic acid and the saccharide used in the step (A). In addition, the hydroxyl groups in the small wood pieces can undergo esterification reaction with the polycarboxylic acid to improve the adhesive properties. The adhesive composed mainly of the polycarboxylic acid and the saccharide can form a reaction system free of organic solvents, formaldehyde, and tertiary amines and other compounds capable of undergoing decomposition to form formaldehyde. This makes it easy to reduce the emission of organic solvents and formaldehyde derived from adhesives.

In the step (A), the method of dispersing the polycarboxylic acid, the saccharide, and ammonium sulfate in a collection of small wood pieces may be, but not limited to, (1) a method of mixing the polycarboxylic acid, the saccharide, and ammonium sulfate simultaneously with a collection of small wood pieces to form a dispersion, or (2) a method that includes mixing ammonium sulfate with a collection of small wood pieces to form a dispersion of ammonium sulfate in the collection of small wood pieces and then mixing the polycarboxylic acid and the saccharide with the collection of small wood pieces to form a dispersion of the polycarboxylic acid and the saccharide in the collection of small wood pieces.

In the method (1), the method of dispersing the polycarboxylic acid, the saccharide, and ammonium sulfate in a collection of small wood pieces may be a method using an aqueous dispersion of the polycarboxylic acid, the saccharide, and ammonium sulfate or a method using a powder of the polycarboxylic acid, the saccharide, and ammonium sulfate. As used herein, the term “an aqueous dispersion of the polycarboxylic acid, the saccharide, and ammonium sulfate” means a liquid including water and the polycarboxylic acid, the saccharide, and ammonium sulfate dissolved or uniformly dispersed in water.

The method using an aqueous dispersion of the polycarboxylic acid, the saccharide, and ammonium sulfate is performed, for example, by mixing the aqueous dispersion with a collection of small wood pieces and then drying the mixture. Since the polycarboxylic acid and the saccharide are highly soluble in water, the aqueous dispersion of them can be easily mixed with the collection of small wood pieces, which are materials to be bonded. In addition, the method uses no organic solvents. This makes the method highly safe for the human body. Also in this method, the polycarboxylic acid and the saccharide are dissolved in each other, so that the modification of the polycarboxylic acid and the saccharide can be accelerated to form a cured polymer, which has high adhesive properties. Water is preferably added in an amount of 15 to 500 parts by weight, more preferably 25 to 400 parts by weight, to 100 parts by weight of the total of the polycarboxylic acid and the saccharide. When the amount of water is in these ranges, a uniform adhesive can be easily obtained, excessive infiltration of the adhesive can be less likely to occur, and the temperature increase can be less likely to be slow due to vaporization in the process of curing the adhesive by heating so that sufficient curing can be easily achieved. The method of mixing the aqueous dispersion of the polycarboxylic acid, the saccharide, and ammonium sulfate with the collection of small wood pieces may be, for example, a method of spraying the aqueous dispersion to the small wood pieces using a spray or other means, or a method of immersing the collection of small wood pieces in the aqueous dispersion.

In the method using a powder of the polycarboxylic acid, the saccharide, and ammonium sulfate, the powder may be mixed with a collection of small wood pieces to form a dispersion of the polycarboxylic acid, the saccharide, and ammonium sulfate in the collection of small wood pieces. The mixing method may include, for example, dispersing the powder in the collection of small wood pieces and optionally mixing them mechanically.

The method (2) includes mixing ammonium sulfate with a collection of small wood pieces to form a dispersion of ammonium sulfate in the collection of small wood pieces and then mixing the polycarboxylic acid and the saccharide with the collection of small wood pieces to form a dispersion of the polycarboxylic acid and the saccharide in the collection of small wood pieces. In the embodiment, ammonium sulfate is used as a catalyst for the esterification reaction of the polycarboxylic acid with hydroxyl groups in the small wood pieces. The use of a salt with relatively low acidity, such as ammonium sulfate, makes it possible to maintain the strength of the parent material. However, if the acidity is low, the activity of the esterification reaction will tend to be low. Therefore, ammonium sulfate as a catalyst for the esterification reaction is previously dispersed in the small wood pieces as parent materials before the polycarboxylic acid and the saccharide for the adhesive are dispersed. This can enhance the activity of the esterification reaction of the polycarboxylic acid with cellulose in the small wood pieces as parent materials. Therefore, a highly water-resistant board with a particularly low rate of weight decrease after boiling can be obtained while loss of bending strength is more reliably prevented.

The method of dispersing ammonium sulfate in the collection of small wood pieces may be, for example, a method using an aqueous dispersion of ammonium sulfate or a method using a powder of ammonium sulfate. As used herein, the term “an aqueous dispersion of ammonium sulfate” means a liquid including water and ammonium sulfate dissolved or uniformly dispersed in water.

The method using an aqueous dispersion of ammonium sulfate is performed, for example, by mixing the aqueous dispersion of ammonium sulfate with the collection of small wood pieces and then drying the mixture. The mixture is preferably dried to an air-dry-hard state although it may be dried to a dry-to-touch state. The concentration of ammonium sulfate in the aqueous dispersion is preferably 5% by weight or more in order to enhance the activity of the esterification reaction of the polycarboxylic acid with cellulose in the small wood pieces as parent materials. The method of mixing the aqueous dispersion of ammonium sulfate with the collection of small wood pieces may be, for example, a method of spraying the aqueous dispersion of ammonium sulfate to the small wood pieces using a spray or other means, or a method of immersing the collection of small wood pieces in the aqueous dispersion of ammonium sulfate.

In the method using a powder of ammonium sulfate, the powder of ammonium sulfate may be mixed with the collection of small wood pieces to form a dispersion of ammonium sulfate in the collection of small wood pieces. The mixing method may include, for example, dispersing the powder of ammonium sulfate in the collection of small wood pieces and optionally mixing them mechanically.

The method (2) is preferably performed in the following manner, so that a highly water-resistant board with a particularly low rate of weight decrease after boiling can be obtained without loss of bending strength. A dispersion of ammonium sulfate in the collection of small wood pieces is formed by mixing the aqueous dispersion of ammonium sulfate with the collection of small wood pieces and then drying the mixture. Subsequently, the polycarboxylic acid and the saccharide are mixed with the collection of small wood pieces to form a dispersion of the polycarboxylic acid and the saccharide in the collection of small wood pieces. In this process, the method of mixing the polycarboxylic acid and the saccharide with the collection of small wood pieces is preferably performed using an aqueous dispersion of the polycarboxylic acid and the saccharide.

Besides the above, the step (A) of dispersing the polycarboxylic acid, the saccharide, and ammonium sulfate in the collection of small wood pieces may use the following method. A dispersion of ammonium sulfate in the collection of small wood pieces is formed by mixing an aqueous dispersion of ammonium sulfate with the collection of small wood pieces and then drying the mixture. Subsequently, a dispersion of the polycarboxylic acid and the saccharide in the collection of small wood pieces is formed by mixing the collection of small wood pieces with a powder of the polycarboxylic acid and the saccharide. Alternatively, a dispersion of ammonium sulfate in the collection of small wood pieces is formed by mixing a powder of ammonium sulfate with the collection of small wood pieces. Subsequently, a dispersion of the polycarboxylic acid and the saccharide in the collection of small wood pieces is formed by mixing an aqueous dispersion of the polycarboxylic acid and the saccharide with the collection of small wood pieces and then drying the mixture.

As to the amount of each raw material added in the step (A), the amount of the polycarboxylic acid is preferably from 2 to 10 parts by weight based on 100 parts by weight of the total of the collection of small wood pieces, the polycarboxylic acid, the saccharide, and ammonium sulfate. The amount of the saccharide is preferably from 5 to 20 parts by weight. The amount of ammonium sulfate is preferably from 0.3 to 5 parts by weight.

The adhesive composed mainly of the polycarboxylic acid and the saccharide may contain other components such as a thickener and a reaction accelerator. The catalyst for the esterification reaction is not limited to only ammonium sulfate. Ammonium sulfate may be used in combination with any other catalyst such as para-toluenesulfonic acid.

In the step (B), the molding pressure, the molding temperature, the molding time, and other conditions in the hot press molding may be set as appropriate depending on the type, shape, and surface properties of the small wood pieces, the thickness of the board, and other factors. The molding temperature is preferably from 140 to 230° C. in order to prevent the degradation of the physical properties of the board, to make the reaction rate less likely to decrease, and to easily achieve sufficient curing. The molding pressure is preferably from 0.5 to 4 MPa in order to sufficiently press-bond the small wood pieces (adherends) with the adhesive composed mainly of the polycarboxylic acid and the saccharide so that the strength of the board can be increased and to prevent too high a molding pressure so that the board can be made less likely to break.

According to the features of the board of the embodiment described above, a highly water-resistant board with a low rate of weight decrease after boiling can be obtained without loss of bending strength in the process of producing the board using an adhesive including a polycarboxylic acid and a saccharide.

### EXAMPLES

Hereinafter, the present invention will be more specifically described with reference to examples. It will be understood that the examples are not intended to limit the present invention. Note that the amounts shown in Tables 1 and 2 are in units of parts by weight.

### Example 1

Jute bast fiber bundles (width: 1 to 2 cm, length: 2 to 4 m) were divided in the longitudinal direction by cutting using a cutter. The cut pieces were then mechanically fibrillated using a garnet machine. In this way, jute plant fibers were obtained with an average fiber length of about 55 mm and an average fiber diameter of about 150 μm.

A 50% by weight aqueous dispersion obtained by mixing 3.3 parts by weight of a polycarboxylic acid (citric acid, manufactured by Wako Pure Chemical Industries, Ltd.), 11.25 parts by weight of a saccharide (sucrose, manufactured by Wako Pure Chemical Industries, Ltd.), and 0.45 parts by weight of ammonium sulfate (manufactured by Wako Pure Chemical Industries, Ltd.) with water was supplied to 85 parts by weight of the resulting plant fibers by spraying. The water was then removed by drying under the conditions of 100° C. and 120 minutes.

Using a simple forming machine (mold inner size: 15 cm square), the dried mixture was then scattered in the mold to form a mat.

Subsequently, using a compact hot press machine, the fiber mat was subjected to hot press molding under the conditions of a temperature of 240° C., a pressure of 116 kg/cm², and a period of 3 minutes to form a 9-mm-thick fiberboard of a 15 cm square size. The fiberboard had a density of 830 kg/m³.

### Example 2

A fiberboard was produced as in Example 1, except that the amounts of ammonium sulfate and the polycarboxylic acid were changed to 1.5 parts by weight and 2.25 parts by weight, respectively.

### Example 3

An aqueous dispersion of ammonium sulfate was supplied to the plant fibers by spraying and then allowed to stand for one day so that the water was removed by drying. Subsequently, after an aqueous dispersion of the polycarboxylic acid and the saccharide was supplied to the plant fibers by spraying, the water was removed by drying under the conditions of 100° C. and 120 minutes. A fiberboard was produced as in Example 1, except that the above process was performed.

### Comparative Example 1

A fiberboard was produced as in Example 1, except that ammonium sulfate was replaced with aluminum sulfate.

### Comparative Example 2

A fiberboard was produced as in Example 2, except that ammonium sulfate was replaced with aluminum sulfate.

### Comparative Example 3

A fiberboard was produced as in Example 1, except that ammonium sulfate was replaced with para-toluenesulfonic acid.

### Comparative Example 4

A fiberboard was produced as in Example 2, except that ammonium sulfate was replaced with para-toluenesulfonic acid.

### Comparative Example 5

A fiberboard was produced as in Example 1, except that ammonium sulfate was replaced with sodium dihydrogen phosphate.

### Comparative Example 6

A fiberboard was produced as in Example 2, except that ammonium sulfate was replaced with sodium dihydrogen phosphate.

### Comparative Example 7

A fiberboard was produced as in Example 1, except that ammonium sulfate was replaced with an organotitanium compound (tetrakis(2-ethylhexyloxy)titanium, TOT (product name) manufactured by Nippon Soda Co., Ltd.).

### Comparative Example 8

A fiberboard was produced as in Example 2, except that ammonium sulfate was replaced with an organotitanium compound (tetrakis(2-ethylhexyloxy)titanium, TOT (product name) manufactured by Nippon Soda Co., Ltd.).

### Comparative Example 9

A fiberboard was produced as in Example 1, except that ammonium sulfate was not added and the polycarboxylic acid was added in an amount of 3.75 parts by weight.

### Comparative Example 10

A fiberboard was produced as in Example 1, except that ammonium sulfate was not added and the plant fibers, the polycarboxylic acids, and the saccharide were added in amounts of 80 parts by weight, 5 parts by weight, and 15 parts by weight, respectively.

### Comparative Example 11

A fiberboard was produced as in Comparative Example 9, except that the time period of the hot press molding using the compact hot press machine was changed to 6 minutes from 3 minutes in Comparative Example 9.

### Evaluations

### Hygroscopic Thickness Swelling Rate

The hydroscopic thickness swelling rate of the fiberboards produced was measured according to JIS A 5908:2003.

### Bending Strength

The bending strength and the bending strength under wet conditions of the fiberboards produced were measured according to JIS A 5908:2003 under normal conditions and after boiling, respectively.

Rate of Weight Decrease after Boiling

The rate of weight decrease of the fiberboards produced was measured after boiling (after immersion in boiled water for 2 hours and then drying at 100° C. for 3 hours).

Table 1 shows the results of the evaluations. In this regard, a guideline for the hygroscopic thickness swelling rate is 12% or less. A guideline for the bending strength is 18 MPa or more under normal conditions and 9 MPa or more after boiling.

TABLE 1

| | | | | | | Comparative | Comparative | Comparative | Comparative |
|---|---|---|---|---|---|---|---|---|---|
| | | | Example 1 | Example 2 | Example 3 | Example 1 | Example 2 | Example 3 | Example 4 |
| Formulation | Plant fibers | | 85 | 85 | 85 | 85 | 85 | 85 | 85 |
| (wt %) | Polycarboxylic | Citric | 3.3 | 2.25 | 3.3 | 3.3 | 2.25 | 3.3 | 2.25 |
| | acid | acid | | | | | | | |
| | Saccharide | Sucrose | 11.25 | 11.25 | 11.25 | 11.25 | 11.25 | 11.25 | 11.25 |

| | (1) Ammonium sulfate | 0.45 | 1.5 | 0.45 | | | | |
|---|---|---|---|---|---|---|---|---|
| | (2) Aluminum sulfate | | | | 0.45 | 1.5 | | |
| | (3) Para-toluenesulfonic | | | | | | 0.45 | 1.5 |
| | acid | | | | | | | |
| | (4) Sodium dihydrogen | | | | | | | |
| | phosphate | | | | | | | |
| | (5) Organotitanium | | | | | | | |
| | compound | | | | | | | |
| Method of dispersing catalyst (1)-(5) | | Spraying | Spraying | Spraying | Spraying | Spraying | Spraying | Spraying |
| | | catalyst | catalyst | catalyst | catalyst | catalyst | catalyst | catalyst |
| | | simul- | simul- | prior to | simul- | simul- | simul- | simul- |
| | | taneously | taneously | poly- | taneously | taneously | taneously | taneously |
| | | with | with | carboxylic | with | with | with | with |
| | | poly- | poly- | acid and | poly- | poly- | poly- | poly- |
| | | carboxylic | carboxylic | saccharide | carboxylic | carboxylic | carboxylic | carboxylic |
| | | acid and | acid and | | acid and | acid and | acid and | acid and |
| | | saccharide | saccharide | | saccharide | saccharide | saccharide | saccharide |
| Hygroscopic thickness swelling rate ( % ) | | 11% | 11% | 8% | 11% | 11% | 14% | 14% |
| Bending | Under normal | 21 | 20 | 21 | 18 | 17 | 16 | 15 |
| strength | conditions | | | | | | | |
| (MPa) | After boiling | 12 | 11 | 13 | 8 | 8 | 8 | 7 |

| | | | | | | | |
|---|---|---|---|---|---|---|---|
| Rate (%) of weight decrease after | 0.6% | 0.7% | 0.1% | 0.8% | 0.9% | 1.5% | 2.1% |
| boiling | | | | | | | |

TABLE 2

| | | | Comparative | Comparative | Comparative | Comparative | Comparative | Comparative | Comparative |
|---|---|---|---|---|---|---|---|---|---|
| | | | Example 5 | Example 6 | Example 7 | Example 8 | Example 9 | Example 10 | Example 11 |
| Formulation | Plant fibers | | 85 | 85 | 85 | 85 | 85 | 80 | 85 |
| (wt %) | Polycarboxylic | Citric | 3.3 | 2.25 | 3.3 | 2.25 | 3.75 | 5 | 3.75 |
| | acid | acid | | | | | | | |
| | Saccharide | Sucrose | 11.25 | 11.25 | 11.25 | 11.25 | 11.25 | 15 | 11.25 |

| | (1) Ammonium sulfate | | | | | — | — | — |
|---|---|---|---|---|---|---|---|---|
| | (2) Aluminum sulfate | | | | | | | |
| | (3) Para-toluenesulfonic | | | | | | | |
| | acid | | | | | | | |
| | (4) Sodium dihydrogen | 0.45 | 1.5 | | | | | |
| | phosphate | | | | | | | |
| | (5) Organotitanium | | | 0.45 | 1.5 | | | |
| | compound | | | | | | | |
| Method of dispersing catalyst (1)-(5) | | Spraying | Spraying | Spraying | Spraying | — | — | — |
| | | catalyst | catalyst | catalyst | catalyst | | | |
| | | simul- | simul- | simul- | simul- | | | |
| | | taneously | taneously | taneously | taneously | | | |
| | | with | with | with | with | | | |
| | | poly- | poly- | poly- | poly- | | | |
| | | carboxylic | carboxylic | carboxylic | carboxylic | | | |
| | | acid and | acid and | acid and | acid and | | | |
| | | saccharide | saccharide | saccharide | saccharide | | | |
| Hygroscopic thickness swelling rate ( % ) | | 14% | 13% | 13% | 12% | 14% | 12% | 10% |
| Bending | Under normal | 16 | 15 | 19 | 18 | 18 | 16 | 13 |
| strength | conditions | | | | | | | |
| (MPa) | After boiling | 8 | 7 | 8 | 7 | 9 | 8 | 7 |

| | | | | | | | |
|---|---|---|---|---|---|---|---|
| Rate (%) of weight decrease after | 1.4% | 1.4% | 1.3% | 1.3% | 1.4% | 1.2% | 1.2% |
| boiling | | | | | | | |

Tables 1 and 2 show that the bending strength under normal conditions and the bending strength after boiling are both at least the guideline level in Examples 1 to 3 where ammonium sulfate used as the catalyst is dispersed together with the polycarboxylic acid and the saccharide in the plant fibers. It is also shown that the rate of weight decrease after boiling in Examples 1 to 3 is significantly lower than that in Comparative Examples 9 to 11 where no ammonium sulfate is added. A comparison between cases where different catalysts are added in the same amount also shows that the rate of weight decrease after boiling in Examples 1 to 3 is significantly lower than that in Comparative Examples 1 to 8 where ammonium sulfate is replaced with a different catalyst.

In particular, the rate of weight decrease after boiling is remarkably lower in Example 3 where after an aqueous dispersion of ammonium sulfate is supplied to the plant fibers by spraying and dried, an aqueous dispersion of the polycarboxylic acid and the saccharide is supplied by spraying, than in Example 1 or 2, which means that the water resistance of the board of Example 3 is particularly good.

1. A method for producing a board, the method comprising the steps of:
(A) dispersing a polycarboxylic acid, a saccharide, and ammonium sulfate in a collection of small wood pieces; and
(B) subjecting the collection of small wood pieces containing the dispersed polycarboxylic acid, saccharide, and ammonium sulfate to hot press molding to form a board comprising the small wood pieces bonded together.

2. The method according to claim 1, wherein the step (A) comprises mixing an aqueous dispersion of ammonium sulfate with the collection of small wood pieces, then drying the mixture to form a dispersion of the ammonium sulfate in the collection of small wood pieces, and then mixing the polycarboxylic acid and the saccharide with the collection of small wood pieces to form a dispersion of the polycarboxylic acid and the saccharide in the collection of small wood pieces.
